(19) United States
(12) Patent Application Publication
(10) Pub. No.: US 2026/0259808 A1
(43) Pub. Date: Sep. 3, 2026

(54) HIERARCHICAL MONITORING OF HARDWARE IN COMPUTING ENVIRONMENTS

(71) Applicant: NVIDIA Corporation, Santa Clara, CA (US)

(72) Inventors: Neeraj Kumar Pandey, Pune (IN); Nisha Nagesh Rao, Pune (IN); Uma Maheswara Reddy Annem, Pune (IN); Rahul Ganpat Jagtap, Pune (IN); Abhishek Anurag, Pune (IN)

(21) Appl. No.: 19/068,254

(22) Filed: Mar. 3, 2025

(51) Int. Cl. G10L 15/22; G06F 11/30

(52) U.S. Cl. CPC G10L 15/22; G06F 11/3006; G10L 2015/223

(57) ABSTRACT

In various examples, techniques for hierarchical monitoring of hardware in computing environments is described herein. Systems and methods described herein allow users to concurrently monitor multiple processors. For instance, a user may provide a request related to a set of processors—such as in the form of user input and/or user speech—where the request identifies at least the set of set of processors along with one or more actions to perform. In response to the request, registration data stored in one or more databases may be used to connect to the set of processors—such as by using one or more connected hosts—perform the action(s). Additionally, in some examples, systems and methods described herein may store the information in one or more additional databases as historical data, where the historical data may later be used to perform additional monitoring operations such as detecting anomalies.

### BACKGROUND

Processors are used in various sectors and/or computing environments—such as data centers, control server rooms, embedded systems, artificial intelligence systems, autonomous machines, robotic systems, gaming systems, and/or so forth—to perform operating tasks. As such, monitoring the processors is important to at least determine information related to the processors—such as firmware versions, core details, memory configurations, temperatures, connected peripherals, operating states, and/or the like—and/or to ensure that the processors are operating as intended. However, current monitoring systems require that users manually check each processor individually by accessing a respective host connected to a processor to retrieve the information, which may require significant effort, domain specific information, and/or time to complete. Additionally, for at least these reasons, current monitoring systems may be unable to monitor multiple processors concurrently, in real-time, and/or using historical information related to the processors.

### SUMMARY

Embodiments of the present disclosure relate to hierarchical monitoring of hardware in computing environments. Systems and methods described herein allow users to quickly, efficiently, and/or concurrently monitor multiple processors. For instance, a user may provide a request related to a set of processors—such as in the form of user input, user speech, and/or the like—where the request identifies at least the set of set of processors along with one or more actions to perform. In response to the request, registration data stored in one or more databases may be used to connect to the set of processors—such as by using one or more connected hosts—to perform the action(s). As described herein, in some examples, the action(s) may be associated with generating information related to the set of processors—such as firmware versions, core details, memory configurations, temperatures, connected peripherals, operating states, and/or any other information—where the information is then provided to the user. Additionally, in some examples, systems and methods described herein may store the information in one or more additional databases as historical data. This way, the historical data may later be used to perform additional monitoring actions, such as retrieving additional information and/or detecting anomalies related to the processors.

In contrast to conventional systems, the systems of the present disclosure, in some embodiments, are able to concurrently monitor multiple processors in order to perform specific actions, such as information retrieval. As such, the systems of the present disclosure are able to monitor the processors in real-time and/or with minimal user interaction. Additionally, and as described herein, the systems of the present disclosure, in some embodiments, use artificial intelligence (e.g., natural language processing models, language models, etc.) to perform the monitoring of the processors. As such, the systems of the present disclosure may simplify and/or automate at least a portion of the monitoring process (e.g., the querying process) as compared to the conventional systems. Furthermore, in contrast to the conventional systems, the systems of the present disclosure, in some embodiments, generate, store, and then analyze historical information related to the processors to perform additional monitoring tasks, such as performance monitoring and/or anomaly detection.

### BRIEF DESCRIPTION OF THE DRAWINGS

The present systems and methods for hierarchical monitoring of hardware in computing environments are described in detail below with reference to the attached drawing figures, wherein:

FIG. 1 illustrates an example of a process for managing hardware in computing environments, in accordance with some embodiments of the present disclosure;

FIGS. 2A-2B illustrate examples of inputting requests associated with monitoring processors, in accordance with some embodiments of the present disclosure;

FIG. 3 illustrates an example of a user interface that provides information associated with monitoring processors, in accordance with some embodiments of the present disclosure;

FIG. 4 illustrates an example of a user interface that provides historical information associated with monitoring processors, in accordance with some embodiments of the present disclosure;

FIG. 5 illustrates an example of a user interface that provides a notification associated with an anomaly, in accordance with some embodiments of the present disclosure;

FIG. 6 illustrates an example of a process for training one or more language models to generate structured data associated with monitoring processors, in accordance with some embodiments of the present disclosure;

FIG. 7 illustrates an example of one or more systems configured to perform one or more of the processes described herein, in accordance with some embodiments of the present disclosure;

FIG. 8 illustrates a flow diagram showing a method for monitoring processors in a computing environment, in accordance with some embodiments of the present disclosure;

FIG. 9 illustrates a flow diagram showing a method for using one or more language models to monitor one or more processors, in accordance with some embodiments of the present disclosure;

FIG. 10 illustrates a flow diagram showing a method for automatically detecting anomalies associated with processors, in accordance with some embodiments of the present disclosure;

FIG. 11A is a block diagram of an example generative language model system suitable for use in implementing at least some embodiments of the present disclosure;

FIG. 11B is a block diagram of an example generative language model that includes a transformer encoder-decoder suitable for use in implementing at least some embodiments of the present disclosure;

FIG. 11C is a block diagram of an example generative language model that includes a decoder-only transformer architecture suitable for use in implementing at least some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

Systems and methods are disclosed for hierarchical management of hardware in computing environments. For instance, a system(s) may store, in one or more databases (also referred to as the “registration database(s)”), registration data corresponding to processors (and/or other types of hardware, software, etc.) associated with one or more computing environments. In some examples, the system(s) may receive at least a portion of the registration data from one or more user device, such as via one or more application programming interfaces (API(s)), as a bulk upload, and/or using any other technique. As described herein, the registration data corresponding to a processor may represent at least an identifier of the processor, an identifier of a host connected to the processor, communication information (e.g., an Internet Protocol address, etc.) for connecting to the host, account information (e.g., a username, password, etc.) for accessing the host, details (e.g., type, model, etc.) associated with the processor, and/or any other information that may be used to monitor the processor. Additionally, a computing environment may include, but is not limited to, a data center, a control server room, an embedded system, an artificial intelligence system, an autonomous machine, a robotic system, a gaming system, and/or any other type of environment that includes one or more processors.

The system(s) may then receive, from one or more user devices, input data representing a request associated with one or more of the processors. As described herein, the input data may include, but is not limited to, selection data representing one or more selections from a user interface, audio data representing user speech, text data representing text, and/or any other type of input data. Additionally, a request may include, but is not limited to, at least one or more identifiers of the processor(s) to monitor, one or more actions to perform with respect to monitoring the processor(s), one or more criteria associated with the action(s), one or more metrics for detecting one or more anomalies, and/or any other information. Furthermore, an action may include, but is not limited to, identifying general information (e.g., firmware versions, core details, memory configurations, temperatures, peripherals connected, operating states, etc.) associated with the processor(s), identifying specific types of information (e.g., firmware version, etc.) associated with the processor(s), identifying one or more processors to perform a task (e.g., a test, etc.), identifying one or more anomalies associated with the processor(s), and/or any other type of action associated with monitoring the processor(s).

In some examples, the system(s) may process at least a portion of the input data to generate structured data in a format that allows the system(s) to monitor the processor(s). For instance, if the input data includes audio data, the system(s) may initially process the audio data using one or more speech processing models (e.g., one or more natural language processing (NLP) models, one or more automatic speech recognition (ASR) models, etc.) that are configured to generate data representing text corresponding to the user speech. The system(s) may then process that data using one or more language models (e.g., one or more large language models, etc.) that are configured to generate the structured data associated with the request from the speech. In some examples, the language model(s) may be trained and/or fine-tuned to generate the structured data representing the format, which is described in more detail herein.

The system(s) may then use the registration database(s) to determine registration information associated with the processor(s) from the request. For instance, the registration information may include at least the connection information and/or the account information for connecting to one or more hosts associated with the processor(s). As such, the system(s) may use the registration information to connect to the host(s) in order to access the processor(s). Once accessed, the system(s) may cause the processor(s) to execute one or more commands that are associated with the action(s) from the request. For a first example, if an action includes identifying general information associated with the processor(s), then the processor(s) may execute a command that causes the processor(s) to generate one or more outputs representing the general information. For a second example, if an action includes identifying specific information associated with the processor(s), such as the firmware version, then the processor(s) may execute a command that causes the processor(s) to generate one or more outputs representing the firmware version.

As described herein, in some examples, such as to allow near real-time and/or real-time monitoring of the processor(s), the system(s) may cause the processor(s) to execute the command(s) at least partially in parallel. For example, if the request is associated with multiple processors, then the system(s) may cause a first processor to execute the command(s) to generate a first output, a second processor to execute the command(s) to generate a second output, a third processor to execute the command(s) to generate a third output, and/or so forth at least partially in parallel with one another. The system(s) may then use the respective outputs from each of the processors to generate a final output associated with the request.

The system(s) may then generate content data representing at least the output(s) from the processor(s). As described herein, the content data may include, but is not limited to, visual data representing visual content (e.g., images, videos, virtual reality displays, augmented reality displays, etc.) describing the output(s), audio data representing speech describing the output(s), and/or any other type of content. The system(s) may then provide the content data to the user device(s) so that the user device(s) may provide the content to one or more users. Additionally, in some examples, the system(s) may store data representing the output(s) in one or more databases (e.g., also referred to as the “historical database(s)”). As described herein, the historical database(s) may be used to generate additional outputs associated with monitoring processors, such as additional outputs that include information describing trend analysis, regression testing, performance tracking, and/or the like over a period of time.

For example, and using the example above with the request associated with the processor(s), the request may be for specific information related to one or more temperatures of the processor(s). As such, the system(s) may perform one or more of the processes described herein to communicate with the processor(s) and determine the output(s) indicating the temperature(s). Additionally, the system(s) may access the historical database(s) to retrieve information related past temperatures associated with the processor(s) over a period of time. The system(s) may then generate the content that not only provides the output(s) from the processor(s) indicating the current temperature(s), but also provides the retrieved information related to the past temperatures. For example, the content may include at least one or more visual representations—such as one or more graphs (and/or other type of visuals)—representing the temperatures of the processor(s) over the period of time.

In some examples, the system(s) may process the output(s) from the processor(s) and/or the data stored in the historical database(s) to detect anomalies associated with the processor(s). For instance, the system(s) may use and/or one or more users may provide metrics for detecting anomalies—such as a set firmware version, a set number of cores, a temperature threshold, a set type of memory, a set type of peripheral, a set type of operating state, and/or the like—where the system(s) then uses one or more of the metrics when processing information related to a processor(s). For example, and again using the example above with the request associated with the processor(s), the system(s) may use the output(s) from the processor(s) to determine that a firmware version being used by a processor does not match a specified firmware version that the processor should be using. As such, the system(s) may further generate the content to include an alert associated with the anomaly. By leveraging processor health, computation tasks can be dynamically allocated based on the condition of individual processors. This approach can be extended beyond processor monitoring to optimize task distribution across various components, enhancing overall system performance and efficiency.

As described herein, at least the language model(s) may be trained and/or fine-tuned to generate the structured data in the format that allows the system(s) to perform one or more of the monitoring processes described herein. For instance, to fine-tune the language model(s), the system(s) (and/or one or more additional systems) may use training input data representing various requests associated with monitoring processors along with corresponding ground truth data representing structured outputs for performing the monitoring. The system(s) may then use the language model(s) to process the training input data to generate predicted outputs associated with the requests. Additionally, the system(s) may determine losses based at least on comparing the predicted outputs to the ground truth outputs and update the language model(s) using at least the losses. The training of the language model(s) performing such a process is described in more detail herein.

Additionally, in some examples, the system(s) (and/or the additional system(s)) may use feedback from users to further train and/or fine-tune the language model(s). For instance, in the example above with the request associated with the processor(s), the system(s) may receive feedback indicating that the output(s) associated with the processor(s) was inaccurate, details about why the output(s) was inaccurate, that the output(s) was accurate, details about why the output(s) was accurate, and/or any other type of feedback. The system(s) may then use at least the request (e.g., the input data), the output(s), and the feedback to further fine-tune the language model(s) such that the performance of the language model(s) improves when processing new inputs.

While the examples herein are directed to monitoring processors, in other examples, similar processes may be used to monitor other types of components of the computing environment(s). For example, similar processes may be used to monitor memory devices, communication interfaces, peripheral devices, sensors, software, and/or the like.

In some examples, the mode(s) (e.g., machine learning models, deep neural networks, language models, LLMs, SLMs, VLMs, multi-modal language models, ASRs, NLPs, perception models, tracking models, fusion models, transformer models, diffusion models, encoder-only models, decoder-only models, encoder-decoder models, neural rendering field (NERF) models, neural networks, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing small language models (SLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

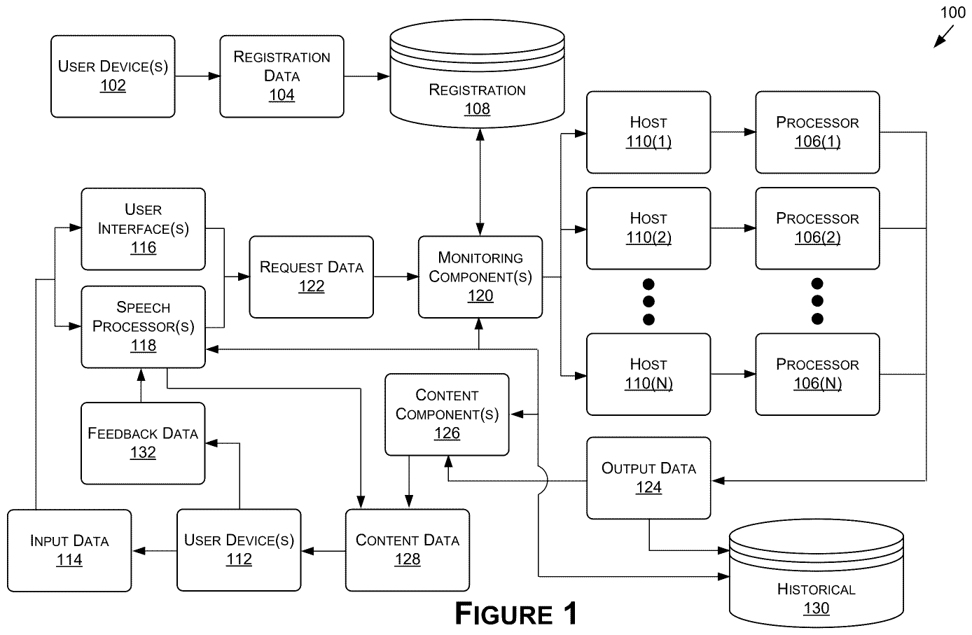

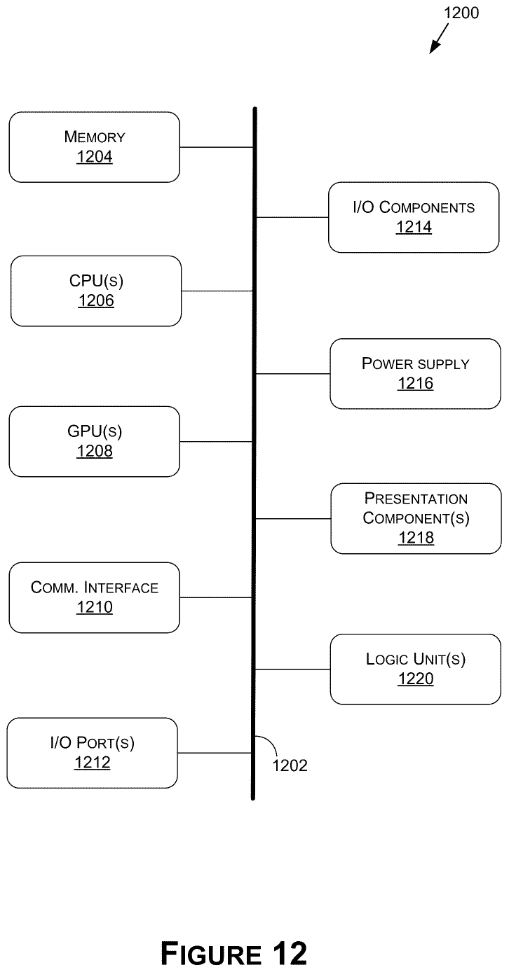

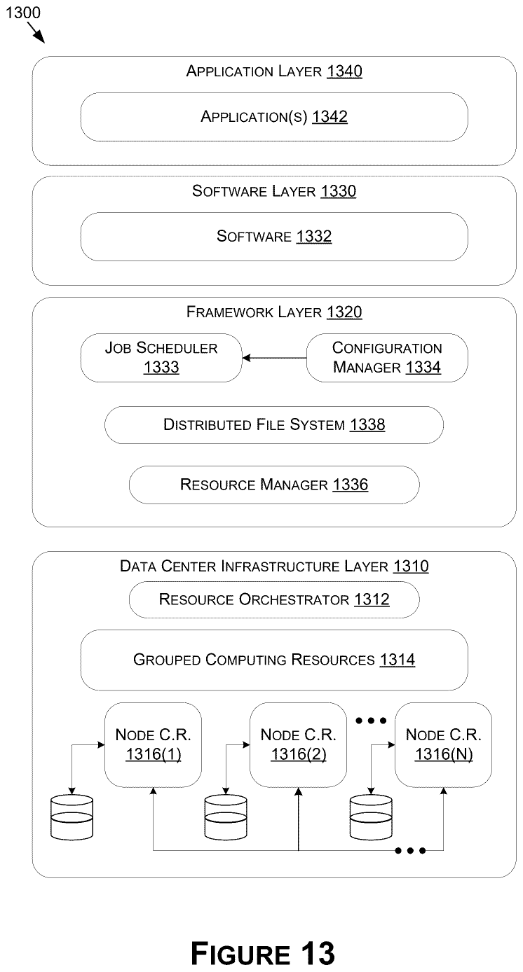

With reference to FIG. 1, FIG. 1 illustrates an example of a process 100 for managing hardware in computing environments, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example computing device 1200 of FIG. 12 and/or example data center 1300 of FIG. 13.

The process 100 may include using one or more user device 102, which may be associated with one or more administrators (and/or other types of users), to generate registration data 104 associated with processors 106(1)-(N) (also referred to singularly as “processor 106” or in plural as “processors 106”) of one or more heterogenous computing environments (e.g., a computing environment 710). These computing environments may span multiple geographic regions and may include diverse hardware architectures, specialized accelerators, and hybrid infrastructures combining cloud, edge, and on-premises computing systems. Examples of computing environments include, but are not limited to, data centers, control server rooms, embedded systems, artificial intelligence systems, autonomous machines, robotic systems, gaming systems, and/or any other environments that include one or more processors. The administrator(s) may use the user device(s) to register the processors 106 with one or more systems (e.g., a system(s) 702), where the process 100 then includes the system(s) storing the registration data 104 in one or more registration databases 108. As described herein, the registration data 104 may be uploaded to the system(s) using any technique, such as one or more APIs, a bulk upload, and/or any other technique. Additionally, the registration data 104 for all of the processors 106 may be generated and stored during a single period of time, or the registration data 104 for different processors 106 may be generated and stored at different periods of time.

As described herein, the registration data 104 may represent at least registration information for communicating with hosts 110(1)-(N) (also referred to singularly as “host 110” or in plural as “hosts 110”) connected to the processors 106. For instance, the registration data 104 associated with a processor 106 may represent at least an identifier of the processor 106, an identifier of a host 110 connected to the processor 106, communication information (e.g., an Internet Protocol address, etc.) for connecting to the host 110, account information (e.g., a username, password, etc.) for accessing the host 110, details (e.g., type, model, etc.) associated with the processor 106, and/or any other type of information associated with the processor 106 and/or the host 110. Additionally, in some examples, the host 110 may include the physical computing machine (and/or other type of device) for which the processor 106 is installed and/or is executing. While the example of FIG. 1 illustrates each host 110 as being connected to a respective processor 106, in other examples, a host 110 may be connected to more than one processor 106.

The process 100 may then include one or more user devices 112, which may be associated with one or more users that monitor the processors 106 of the computing environment, generating input data 114 associated with monitoring at least a portion of the processors 106. As described herein, the input data 114 may include, but is not limited to, selection data representing one or more selections, audio data representing user speech, text data representing text, and/or any other type of input data. Additionally, the input data 114 may represent a request—such as a query, a question, an inquiry, a command, and/or any other type of request—associated monitoring the processor(s) 106. For instance, input data 114 may represent at least one or more identifiers of the processor(s) 106 to monitor, one or more actions to perform regarding monitoring the processor(s) 106, one or more criteria associated with the action(s), one or more metrics for detecting one or more anomalies, and/or any other information.

As described herein, an action may include, but is not limited to, identifying general information (e.g., firmware versions, core details, memory configurations, temperatures, peripherals connected, operating states, etc.) associated with the processor(s) 106, identifying specific types of information (e.g., firmware version, etc.) associated with the processor(s) 106, identifying one or more processors 106 to perform a task (e.g., a test, etc.), identifying one or more types of processors 106 (e.g., a specific model of processor, etc.), identifying one or more processors 106 operating in a specific state (e.g., being utilized, not being utilized, etc.), and/or any other action associated with monitoring the processor(s) 106. In some examples, a request may include a single action associated with monitoring the processor(s) 106 while, in other examples, a request may include multiple actions associated with monitoring the processor(s) 106.

As shown, in some examples, the user(s) of the user device(s) 112 may provide one or more inputs, which are represented by the input data 114, to one or more user interfaces 116 associated with generating requests to monitor the processors 106. Additionally, or alternatively, in some examples, the user(s) of the user device(s) 112 may provide the requests using speech, where the input data 114 then includes audio data representing the user speech from the user(s). In such examples, the process 100 may then include processing the audio data using one or more speech processors 118 to generate structured data associated with the requests. For example, a speech processor 118 may include, but is not limited to, a NLP model, an ASR model, a language model, and/or any other type of speech processing model.

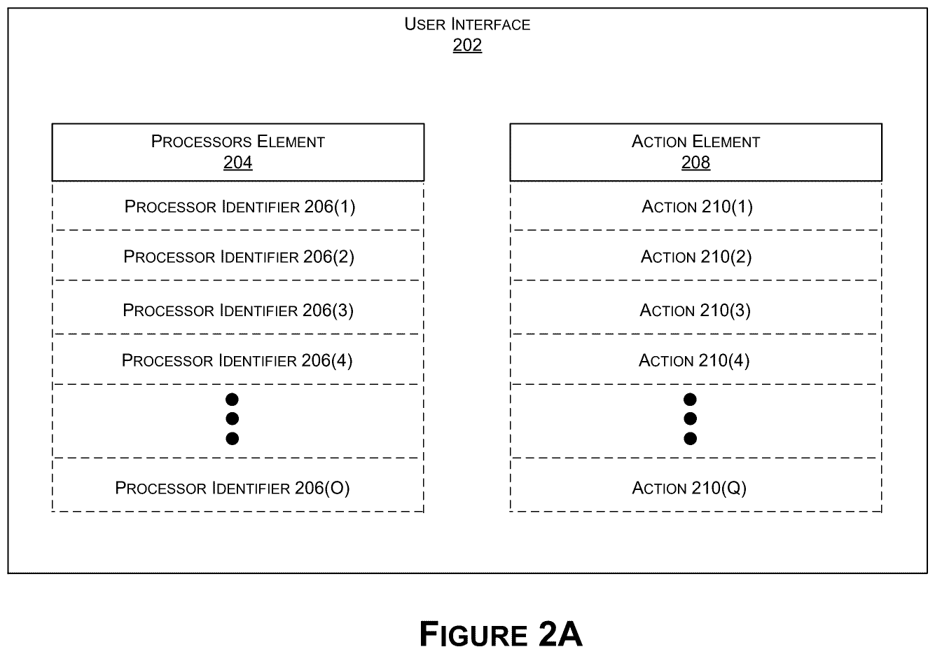

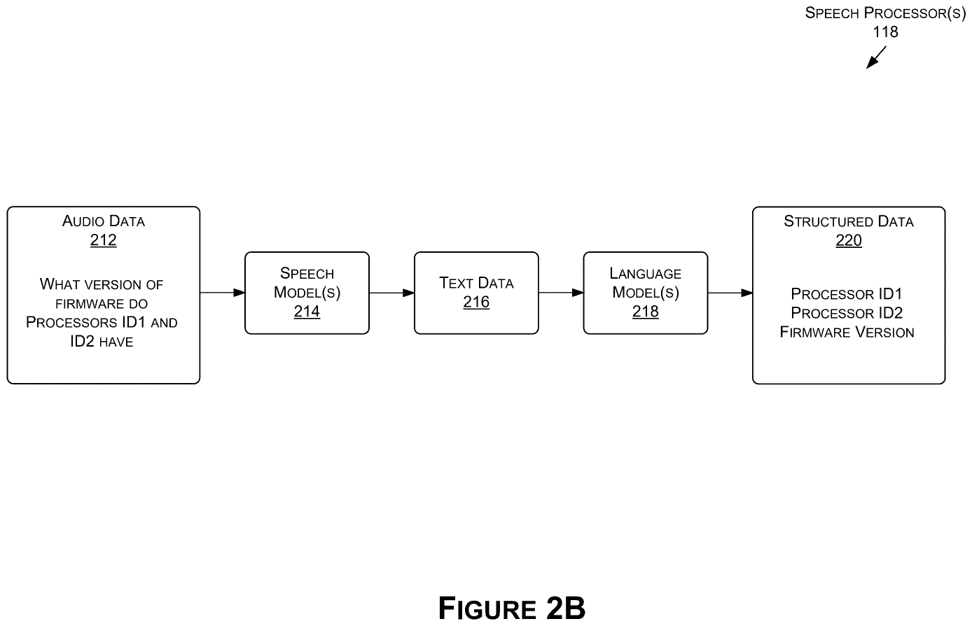

For more details, FIGS. 2A-2B illustrate examples of inputting requests associated with monitoring processors, in accordance with some embodiments of the present disclosure. As shown by the example of FIG. 2A, a user may be provided with a user interface 202 that includes various interface elements for generating a request to monitor one or more processors. For instance, the user interface 202 includes at least a processor element 204 that provides a list of processor identifiers 206(1)-(O) associated with different processors (e.g., the processors 106) that may be monitored. As described herein, an identifier may include, but is not limited to, an alphabetic identifier, a numerical identifier, an alphanumeric identifier, a name, a code, and/or any other type of identifier.

Additionally, the user interface 202 includes an action element 208 that provides a list of actions 210(1)-(Q) that may be performed when monitoring the processors. For example, the first action 210(1) may be associated with identifying general information associated with processors, the second action 210(2) may be associated with identifying firmware versions associated with processors, the third action 210(3) may be associated with identifying peripherals connected to the processors, the fourth action 210(4) may be associated with identifying one or more processors to perform a specific type of test, and/or so forth. While the example of FIG. 2A illustrates the processor element 204 and the action element 208 as including specific types of interface elements, such as lists, in other examples, the processor element 204 and/or the action element 208 may include any other type of interface element for inputting information (e.g., a text box, a slider, buttons, etc.). Additionally, in some examples, the user interface 202 may include additional interface elements for adding additional information (e.g., criteria, metrics, etc.) associated with requests to monitor processors.

Next, as shown by the example of FIG. 2B, a user may provide input in the form of user speech, where a user device then generates audio data 212 representing the user speech. For instance, the user speech may indicate at least which processors to monitor, such as processor ID1 and processor ID2, along with an action to perform with regard to the monitoring, such as identifying firmware versions of the processors. However, in other examples, user speech may indicate any number of processors and/or any other types of actions associated with monitoring the processors. Additionally, in some examples, user speech may indicate additional information for performing the monitoring, such as criteria, metrics, and/or the like. For some examples, user speech may represent requests such as “Please provide general information about the processors,” “List the processors which may be used for performance testing with this specific criteria,” “Provide a list of processors having a particular set of peripherals,” or “List the processors that include this model.”

The speech processor(s) 118 may then include one or more speech models 214 to process the audio data 212 and generate text data 216 associated with the user speech. As described herein, the speech model(s) 214 may include, but is not limited to, a NLP model, an ASR model, and/or any other type of model that is configured to perform at least a portion of the processes described herein. Additionally, in some examples, the text data 216 may represent text corresponding to the use speech, such as a transcript of the user speech. However, in other examples, the text data 216 may represent other types of outputs associated with the user speech, such as a sentiment score of the translated user speech, a list of entities included in the user speech (e.g., the processor ID1, the processor ID2, the action, etc.), a summary of the user speech, a classification label, and/or any other type of output.

The speech processor(s) 118 may then include one or more language models 218 to process the text data 216 and generate structured data 220 associated with the user speech. As described in more detail herein, in some examples, the language model(s) 218 may be trained and/or fine-tuned to generate the structured data 220 in a format that may be used to perform one or more of the monitoring processes described herein. For instance, in the example of FIG. 2B, the structured data 220 may represent at least the identifiers of the processors to monitor along with the action to perform for monitoring the processors. However, in other examples, structured data may include any other type of format that is associated with performing one or more of the monitoring processes described herein.

Referring back to the example of FIG. 1, the process 100 may include one or more monitoring components 120 receiving request data 122 representing the request from the user(s). For example, the request data 122 may include selection data representing the selections input into the user interface(s) 116, the structured data output by the speech processor(s) 118, and/or any other type of data representing the request. The process 100 may then include the monitoring component(s) 120 accessing the registration database(s) 108 to retrieve registration data 104 associated with at least the processor(s) 106 from the request. For example, if the request is associated with monitoring the processors 106(1)-(2), then the monitoring component(s) 120 may retrieve registration data 104 associated with the processors 106(1)-(2). As described herein, the retrieved registration data 104 may be associated with connecting to and/or accessing the host(s) 110 of the processor(s) 106.

For instance, the process 100 may then include the monitoring component(s) 120 using the registration data 104 to establish one or more connections with the host(s) 110, where a connection is represented by the arrow between the monitoring component(s) 120 and the host 110. For example, the monitoring component(s) 120 may use at least the communication information to establish the connection(s) with the host(s) 110. In some examples, the monitoring component(s) 120 may then use the account information to gain access to the host(s) 110, such as by logging into one or more accounts. This way, the monitoring component(s) 120 is able to communicate with the host(s) 110, the processor(s) 106, and/or one or more peripherals connected to the processor(s) 106.

For instance, the process 100 may include the monitoring component(s) 120 causing the processor(s) 106 to execute one or more commands associated with the monitoring action(s). For a first example, if an action includes identifying general information associated with a processor(s) 106, then a command executed by the processor(s) 106 may cause the processor(s) 106 to determine the general information. For a second example, if an action includes identifying specific information associated with a processor(s) 106, then a command executed by the processor(s) 106 may cause the processor(s) to determine the specific information. For instance, if the specific information includes peripherals connected to the processor(s) 106, then the command may cause the processor(s) 106 to determine the peripherals that are connected to the processor(s) 106, such as by further communicating with the peripherals.

In any of these examples, the process 100 may include the processor(s) 106 outputting data 124 associated with the request, where the output data 124 represent at least information determined by the processor(s) 106 based on executing the command(s). For a first example, if a request is associated with determining general information about the processors 106(1)-(2), then the first processor 106(1) may generate first output data 124 representing the general information associated with the first processor 106(1) and the second processor 106(2) may generate second output data 124 representing the general information associated with the second processor 106(2). For a second example, if a request is associated with determining firmware versions associated with all of the processors 106, then each of the processors 106 may generate respective output data 124 representing a respective firmware version associated with each of the processors 106.

As described herein, in some examples, such as to reduce the latency of performing the monitoring and/or to perform the monitoring in real-time, the monitoring component(s) 120 may cause multiple processors 106 to execute the command(s) at least partially in parallel with respect to one another rather than individually. For instance, and using the first example above where the request is associated with determining general information about the processor(s) 106(1)-(2), the first processor 106(1) may execute the command(s) to determine the first output data 124 at least partially while the second processor 106(2) is executing the command(s) to determine the second output data 124. In some examples, the monitoring component(s) 120 is able to cause the processors 106 to execute the command(s) at least partially in parallel by establishing multiple connections with the processors 106 concurrently.

In some examples, the monitoring component(s) 120, the host(s) 110, and/or the processor(s) 106 may perform additional processing with respect to monitoring requests to generate the output data 124. For instance, the monitoring component(s) 120, the host(s) 110, and/or the processor(s) 106 may perform additional processing to determine whether one or more processors 106 being monitored satisfy one or more criteria related to different actions. For a first example, if a request is associated with identifying processors 106 that are capable of performing a test (e.g., performance test, a power test, etc.), then the monitoring component(s) 120, the host(s) 110, and/or the processors 106 may use the information determined by the processors 106 to further determine whether one or more of the processors 106 satisfy criteria for performing the test. In such an example, the criteria may be determined using the request, determined using stored data representing general criteria for tests, and/or any other technique. Additionally, the output data 124 may represent the processor(s) 106 that may perform the test.

For a second example, if a request is associated with identifying processors 106 that include a specific version of firmware, then the monitoring component(s) 120, the host(s) 110, and/or the processors 106 may use the information determined by the processors 106 to further determine whether one or more of the processors 106 execute the specific firmware version. As such, the output data 124 may represent the processor(s) 106 that executes the firmware version. Still, for a third example, if a request is associated with identifying processors 106 that are connected to a specific type of peripheral, then the monitoring component(s) 120, the host(s) 110, and/or the processors 106 may use the information determined by the processors 106 to further determine whether one or more of the processors 106 are connected to the type of peripheral. As such, the output data 124 may represent the processor(s) 106 that is connected to the type of peripheral. While these are just three examples of performing additional processing with respect to criteria to generate the output data 124, in other examples, additional and/or alternative criteria may be used to generate the output data 124.

The process 100 may then include one or more content components 126 using at least a portion of the output data 124 to generate content data 128 representing content associated with the request. As described herein, the content data 128 may include, but is not limited to, visual data representing visual content (e.g., images, videos, virtual reality displays, augmented reality displays, etc.) describing the output(s), audio data representing speech describing the output(s), and/or any other type of content. For instance, in some examples, the content may include at least information output by the processor(s) 106, information determined based on further analyzing the outputs from the processor(s) 106 using the additional criteria(s), and/or any other information. The process 100 may then include providing the user device(s) 112 with the content data 128 so that the user device(s) 112 may provide the content to the user(s).

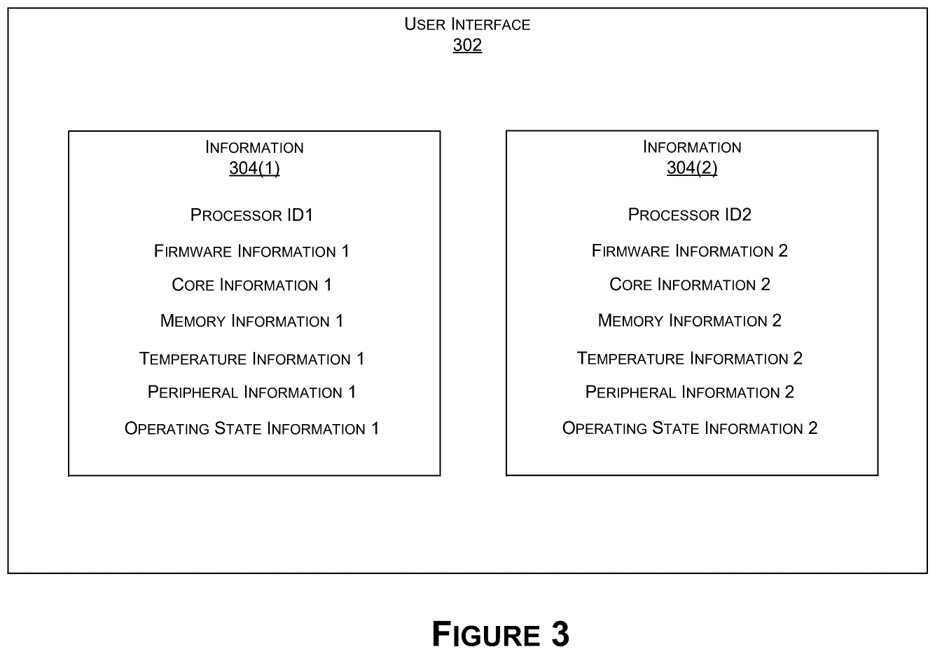

For instance, FIG. 3 illustrates an example of a user interface 302 that provides information associated with monitoring processors, in accordance with some embodiments of the present disclosure. As shown, the user interface 302 includes information 304(1)-(2) (also referred to as “information 304”) for two processors that were monitored using one or more of the processes described herein. Additionally, the information 304 may include at least firmware information, core information, memory information, temperature information, peripheral information, and operating state information associated with the processors. For example, the request may have been for general information associated with the processors. While the example of FIG. 3 illustrates specific types of information that may be provided using the user interface 302, in other examples, the user interface 302 may provide additional and/or alternative information.

Referring back to the example of FIG. 1, in some examples, the process 100 may include storing at least a portion of the output data 124 in one or more historical databases 130. For instance, the historical database(s) 130 may store historical data associated with the processors 106, such as historical data representing firmware versions, core details, memory configurations, temperatures, peripherals connected, operating state, and/or any other type of information associated with the processors 106 that is generated at different instances in time. In some examples, the historical data may be generated and/or stored whenever users request monitoring of the processors 106, such as by using output data 124 associated with requests. Additionally, or alternatively, in some examples, the historical data may be generated and/or stored based on the occurrence of one or more other events, such as the elapse of specific time intervals, when problems occur with regard to the processors 106, and/or any other event.

In some examples, the content component(s) 126 may further use at least a portion of the historical data from the historical database(s) 130 when generating content associated with requests, such as by providing additional information associated with the processor(s) 106 being monitored. For a first example, if a request is for temperature information associated with processors 106, the content component(s) 126 may use output data 124 from the processors 106 that represents the current temperatures of the processors 106 along with historical data from the historical database(s) 130 that represents historical temperatures of the processors 106 to generate content indicating a history of temperatures associated with the processors 106. For a second example, if a request is for processors 106 that are capable of performing a test, the content component(s) 126 may use output data 124 from the processors 106 along with historical data from the historical database(s) 130 to generate content indicating which processors 106 have previously performed the test and/or which processors are capable of performing the test.

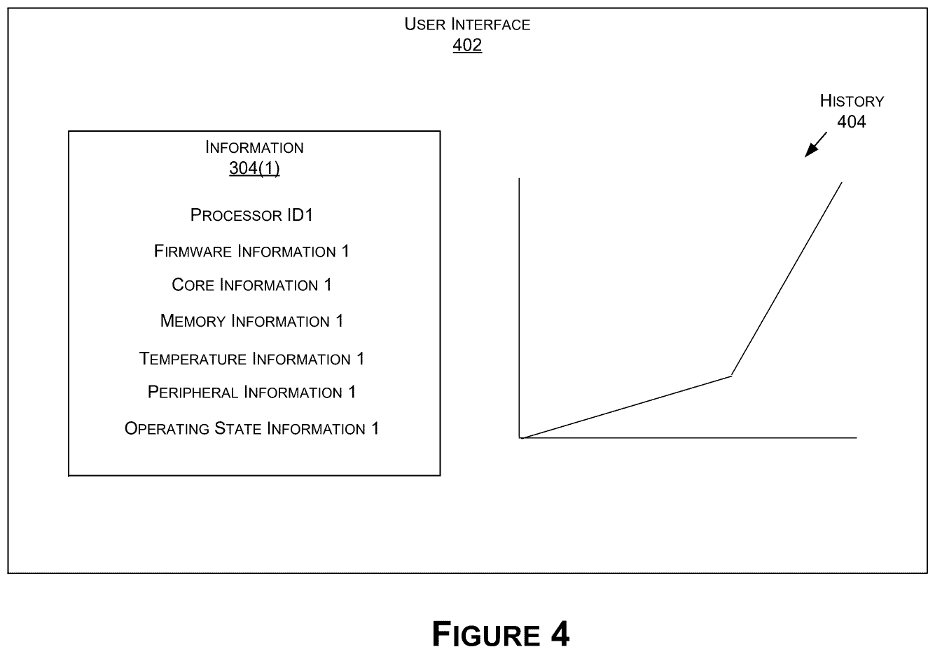

For instance, FIG. 4 illustrates an example of a user interface 402 that provides historical information associated with monitoring processors, in accordance with some embodiments of the present disclosure. As shown, the user interface 302 may include the information 304(1) for one of the processors that was monitored using one or more of the processes described herein. Additionally, the user interface 402 includes historical information 404 associated with the processor. While the example of FIG. 4 illustrates the historical information 404 as including a graph, in other examples, the historical information 404 may be illustrated using any other type of visual content. As such, by providing the both the current information 304(1) and the historical information 404 associated with the processor using the user interface 402, the user(s) is then able to determine the status of the processor over a period of time.

Referring back to the example of FIG. 1, the process 100 may include the user device(s) 112 providing feedback associated with content corresponding to requests, where the feedback is represented by feedback data 132. As described herein, feedback associated with a request may include, but is not limited to, an indication that the information is inaccurate, details of why the information is inaccurate, an indication that the information is accurate, details of why the information is accurate, a request for additional information (e.g., a new request that includes one or more new actions to perform with regard to the monitoring), and/or any other type of feedback that may be provided. In some examples, the process 100 may then include performing one or more tasks using the feedback, such as further training the language model(s) (which is described in more detail herein), performing an updated monitoring of the processor(s) 106, and/or any other task.

For example, the process 100 may include the speech processor(s) 118 processing the feedback data 132 to generate updated request data 122 associated with monitoring the processor(s) 106. For instance, if the feedback indicates why initial information is inaccurate, then the updated request data 122 may represent a new request for monitoring the processor(s) 106 that is generated based on the details from the feedback. At least a portion of the process 100 described herein may then be performed to generate updated output data 124 for the updated request, where the content component(s) 126 then uses the updated output data 124 to generate updated content. This process 100 may then continue to repeat for any number of iterations in order to refine the results and provide the most relevant information associated with monitoring the processor(s) 106. For instance, this process 100 may continue to repeat until the feedback indicates that the results are accurate.

As further illustrated in the example of FIG. 1, the process 100 may include the speech processor(s) 118 using the historical data from the historical database(s) 130 to directly generate content associated with requests. For instance, the speech processor(s) 118 may process audio data representing user speech corresponding to a request—using one or more of the processes described herein—to generate request data 122 associated with the request. As described herein, the request data 122 may indicate at least one or more processors 106 to monitor, one or actions to perform with regard to the monitoring, one or more criteria for the action(s), and/or one or more metrics associated with the action(s). The speech processor(s) 118 may then use the request data 122 to retrieve historical data associated with the request. For instance, the speech processor(s) 118 may retrieve at least the historical data associated with the processor(s) and/or the historical data that is associated with the processor(s) and the action(s). The speech processor(s) 118 may then use the historical data (e.g., the text from the historical data) to generate content data 128 associate with the request. For example, the content data 128 may represent at least a response that includes information corresponding to the request.

Additionally, in some examples, the process 100 may include the monitoring component(s) 120 using the historical data and/or output data 124 to detect one or more anomalies associated with the processors 106. For instance, the monitoring component(s) 120 may analyze the historical data and/or the output data 124 using one or more metrics. As described herein, the metric(s) may be provided as part of a request, previously set by one or more users, standard for monitoring the processors 106, and/or generated, obtained, or received using any other technique. Additionally, a metric may include, but is not limited to, a set firmware version, a set number of cores, a temperature threshold, a set type of memory, a set type of peripheral, a set operating state, and/or any other metric.

Based at least on the analysis, the monitoring component(s) 120 may determine whether at least one of the metrics is satisfied. For example, the monitoring component(s) 120 may determine whether a current firmware version is different than a set firmware version, a number of cores is different than a set number of cores, a minimum temperature threshold is not met, a maximum threshold temperature is exceeded, a type of memory is different than a set type of memory, a peripheral that should be connected is not connected, a peripheral that should not be connected is connected, an operating state differs from a set operating state, and/or the like. If the monitoring component(s) 120 determines that a metric is satisfied, then the monitoring component(s) 120 may determine that an anomaly is detected. However, if the monitoring component(s) 120 determines that no metrics are satisfied, then the monitoring component(s) may determine that no anomaly is detected.

The process 100 may then include the monitoring component(s) 120 causing the content component(s) 126 to generate content data 128 representing a notification (e.g., an alert, a warning, etc.) based on an anomaly being detected. Additionally, the content data 128 may be provided to the user device(s) 112 so that the user device(s) 112 is able to provide the content representing the notification to the user(s). This way, the process 100 is able to automatically determine when there is an anomaly with regard to the processors 106 and provide a warning to the user(s).

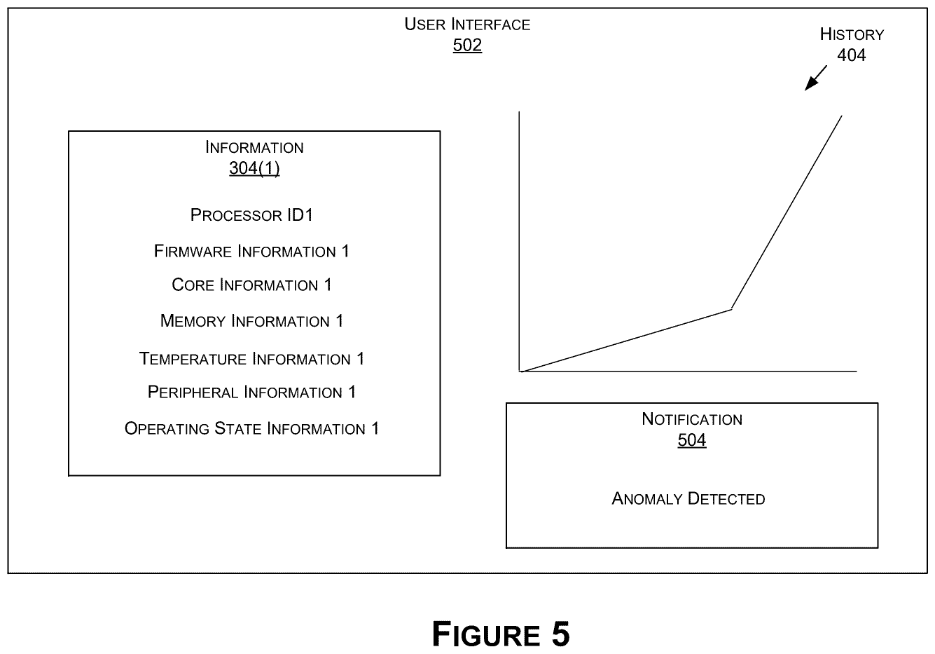

For instance, FIG. 5 illustrates an example of a user interface 502 that provides a notification associated with an anomaly, in accordance with some embodiments of the present disclosure. As shown, the user interface 502 may include the information 304(1) for one of the processors that was monitored using one or more of the processes described herein along with the historical information 404 associated with the processor. Additionally, the user interface 502 includes a notification 504 that indicates that an anomaly associated with the processor was detected. As such, by performing these processes, the user(s) is able to use the user interface 502 to determine that the anomaly is occurring, determine the current information 304(1) that may be causing the anomaly, and/or determine the historical information 404 leading to anomaly occurring. While the examples of FIGS. 2A, 34, and 5 illustrates visual content in a 2D format, augmented reality (AR), virtual reality (VR), or mixed reality (MR) environments can be utilized to enhance the visualization (e.g., 3D format) and interaction with visual content. For example, AR can overlay real-time processor metrics, historical trends, or error notifications directly onto physical hardware (e.g., processors, etc.), allowing users to point their devices at servers or computing equipment to view critical performance data in context. For another example, VR can allow remote teams to collaboratively monitor and analyze processor data in an immersive, shared virtual space. Users may interact with data visualizations in VR to refine queries with gestures, such as pointing at anomalies to zoom in or requesting deeper insights on specific performance trends. These AR/VR/MR capabilities provide an intuitive, interactive approach to understanding complex processor data.

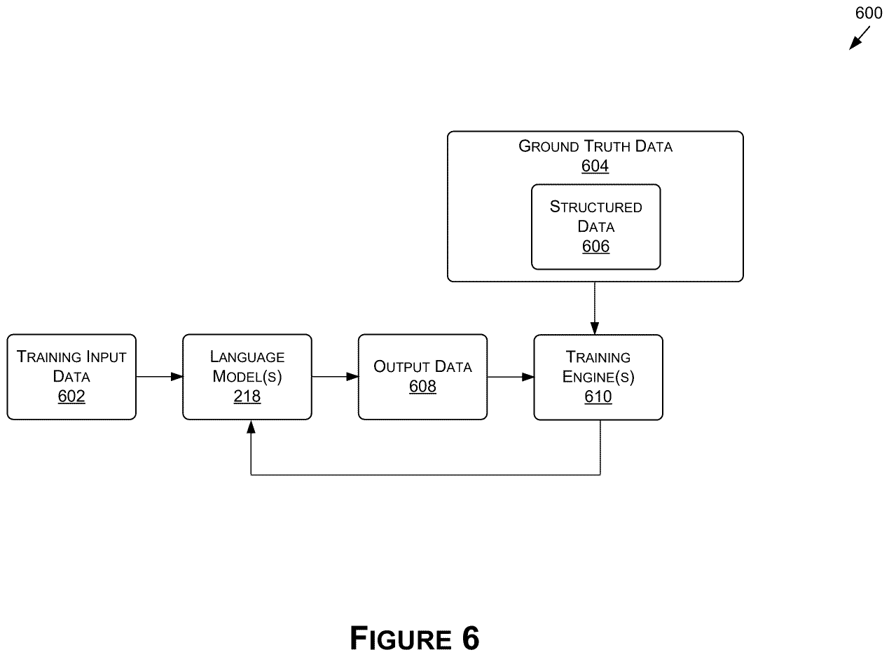

As described herein, in some examples, one or more models of the speech processor(s) 118 may be trained and/or fine-tuned. For instance, FIG. 6 illustrates an example of a process 600 for training the language model(s) 218 to generate structured data associated with monitoring processors, in accordance with some embodiments of the present disclosure.

As shown, the language model(s) 218 may be trained using training input data 602. In some examples, the training input data 602 may represent instances of text, where an instance of text corresponds to a request for monitoring one or more processors. For example, an instance of text may include “List all of the processors which may be used for performing a test,” “List all of the processors that include a first version of firmware,” “Please provide information about processor 1 and processor 2,” and/or any other instance of text representing a request. In some examples, the training input data 602 may be real produced (e.g., generated specifically for training the language model(s) 218), generated from actual requests by users (e.g., generated using the input data 114, such as based on user feedback), synthetically produced, and/or any combination thereof.

The language model(s) 218 may be trained using the training input data 602 along with corresponding ground truth data 604. As shown, in some examples, the ground truth data 604 may include at least structured data 606 in the format that is associated with monitoring the processors. In some examples, for each instance of the training input data 602, there may be corresponding ground truth data 604. For instance, for an instance of the training input data 602 that represents a request associated with monitoring processors, there may be corresponding structured data 606 in the format and generated using the text from the request. In some examples, the ground truth data 604 may be real produced, synthetically produced, human labeled, machine labeled, and/or any combination thereof.

As shown, the process 600 may include the language model(s) 218 processing the training input data 602 to generate output data 608 corresponding to the training input data 602. For instance, the output data 608 may also include structure data corresponding to the text from the instances of the training input data 602. The process 600 may then include one or more training engines 610 using one or more loss functions that measure loss (e.g., error) in the output data 608 as compared to the ground truth data 604. For instance, in some examples, the loss function(s) may measure the loss based at least on differences between the structured data from the output data 608 and the structure data 606. The training engine(s) 610 may then perform backward pass computations to recursively compute gradients of the loss function(s) with respect to training parameters in order to update the parameters and/or weights of the language model(s) 218.

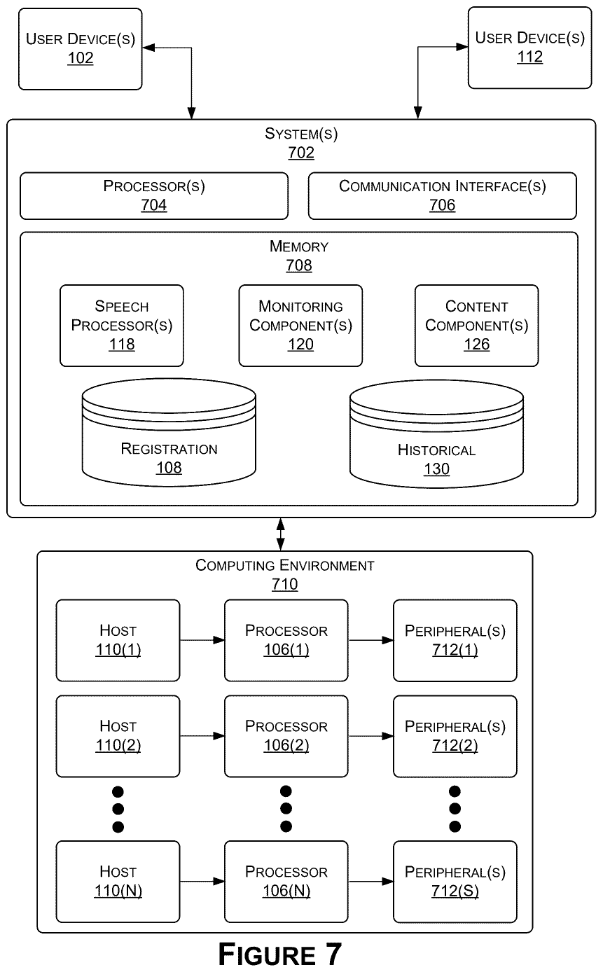

FIG. 7 illustrates an example of one or more systems 702 configured to perform one or more of the processes described herein, in accordance with some embodiments of the present disclosure. As shown, the system(s) 702 may include at least one or more processors 704 (which may include, and/or be similar to, a CPU 1206 and/or a GPU 1208), one or more communication interfaces 706 (which may include, and/or be similar to, a communication interface(s) 1210), and a memory 708 (which may include, and/or be similar to, a memory 1204). Additionally, the memory 708 may store at least the registration database(s) 108, the speech processor(s) 118, the monitoring component(s) 120, the content component(s) 126, and the historical database(s) 130. Furthermore, the processor(s) 704 may execute at least the speech processor(s) 118, the monitoring component(s) 120, and the content component(s) 126 to perform at least some of the processes described herein.

As further illustrated in the example of FIG. 7, the system(s) 702 may communicate with the user device(s) 102, such as to receive the registration data 104 associated with the processors 106, and the user device(s) 112, such as to receive the input data 114 and send the content data 128 associated with monitoring the processors 106. The system(s) 702 may also communicate with a computing environment(s) 710 that includes the hosts 110, the processors 106, and peripherals 712(1)-(S) (also referred to singularly as “peripheral 712” or in plural as “peripherals 712”). As described herein, the system(s) 702 may use the registration data from the registration database(s) 108 to communicate with the hosts 110, the processors 106 via the hosts 110, and/or the peripherals 712 via the processors 106.

As described herein, while the examples of FIGS. 1-7 describe techniques for monitoring the processors 106, in some examples, similar techniques may be used to monitor other types of components of the computing environment(s) 710. For example, similar techniques may be used to monitor memory devices, communication interfaces, peripheral devices, sensors, software, and/or any other type of components of the computing environment(s) 710. In such examples, the system(s) 702 may still receive registration data from the user device(s) 102, where the registration data represents registration information associated with the components, and store the registration data in the registration database(s) 108. The system(s) 702 may then perform one or more of the processes described herein to receive requests associated with monitoring the components, generate content data 128 representing results associated with the monitoring, and provide the content data 128 to the user device(s) 112. In an embodiment, the content data 128 may include information related to optimizing assignment of tasks across various components in the computing environment(s) 710. For example, the system(s) 702 implementing models described herein and/or other generative AI models can analyze real-time performance data of the components to predict the optimal allocation of computational resources. By dynamically adjusting workloads based on component health and resource availability, the system(s) 702 can ensure that tasks are assigned to the most capable components, improving overall efficiency and minimizing bottlenecks. The models can also anticipate future workload demands and proactively distribute tasks, thereby preventing overloading any individual component and ensuring balanced system performance across the computing environment(s) 710. This adaptive approach can be extended to all components monitored within the system(s) 702 to ensure continuous and seamless operations across the computing environment(s) 710.

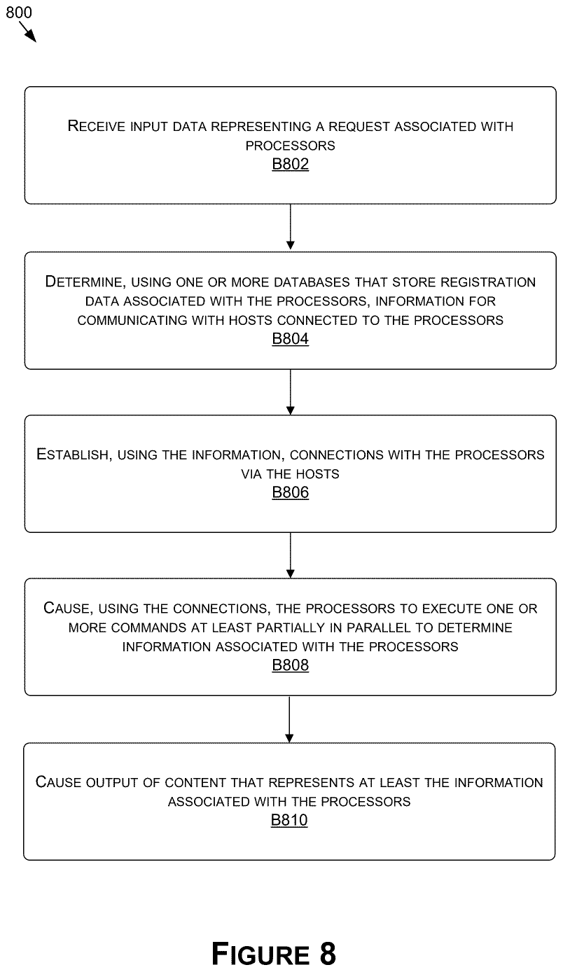

Now referring to FIGS. 8-10, each block of methods 800, 900, and 1000, described herein, comprises a computing process that may be performed using any combination of hardware, firmware, and/or software. For instance, various functions may be carried out by a processor executing instructions stored in memory. The methods 800, 900, and 1000 may also be embodied as computer-usable instructions stored on computer storage media. The methods 800, 900, and 1000 may be provided by a standalone application, a service or hosted service (standalone or in combination with another hosted service), or a plug-in to another product, to name a few. In addition, these methods 800, 900, and 1000 are described, by way of example, with respect to FIGS. 1 and 7. However, these methods 800, 900, and 1000 may additionally or alternatively be executed by any one system, or any combination of systems, including, but not limited to, those described herein.

FIG. 8 illustrates a flow diagram showing a method 800 for monitoring processors in a computing environment, in accordance with some embodiments of the present disclosure. The method 800, at block B802, may include receiving input data representing a request associated with processors. For instance, the system(s) 702 may receive the input data 114 from the user device(s) 112, where the input data 114 represents at least the request for monitoring the processors 106. In some examples, the input data 114 may be associated with one or more inputs to the user interface(s) 116, such as by selecting the processors 106 and/or one or more actions associated with monitoring the processors 106. Additionally, or alternatively, in some examples, the input data 114 may include audio data that is processed using the speech processor(s) 118. In either example, the input data 114 may be used to generate the request data 122 associated with the request.

The method 800, at block B804, may include determining, using one or more databases that store registration data associated with at least the processors, information for communicating with hosts connected to the processors. For instance, the monitoring component(s) 120 may access the registration database(s) 108 to retrieve the registration information for communicating with the hosts 110 connected to the processors 106. As described herein, in some examples, the monitoring component(s) 120 may use information from the request data 122, such as information that identifies the processors 106 to monitor, to retrieve the registration information from the registration database(s) 108.

The method 800, at block B806, may include establishing, using the information, connections with the processors via the hosts. For instance, the monitoring component(s) 120 may use the registration information to establish the connections with the processors 106 via the hosts 110. Additionally, in some examples, such as based on the request, the monitoring component(s) 120 may establish connections with the peripherals 712 connected to the processors 106.

The method 800, at block B808, may include causing, using the connections, the processors to execute one or more commands at least partially in parallel to determine information associated with the processors. For instance, the monitoring component(s) 120 may cause the processors 106 to execute the command(s) to generate the output data 124. As described herein, in some examples, the monitoring component(s) 120 may cause the processors 106 to execute the command(s) at least partially in parallel with one another. Additionally, the output data 124 may represent the information associated with the processors 106 from the request. For instance, the output data 124 may represent at least the firmware versions, the core details, the memory configurations, the temperatures, the peripherals connected, the operating states, and/or the like associated with the processors 106.

The method 800, at block B810, may include causing output of content that represents at least the information associated with the processors. For instance, the content component(s) 126 may use at least a portion of the output data 124 to generate the content data 128 representing the information associated with the processors 106. In some examples, the content component(s) 126 may further use historical data from the historical database(s) 130 to generate the content data 128. The system(s) 702 may then send the content data 128 to the user device(s) 112 such that the user device(s) 112 may provide the content.

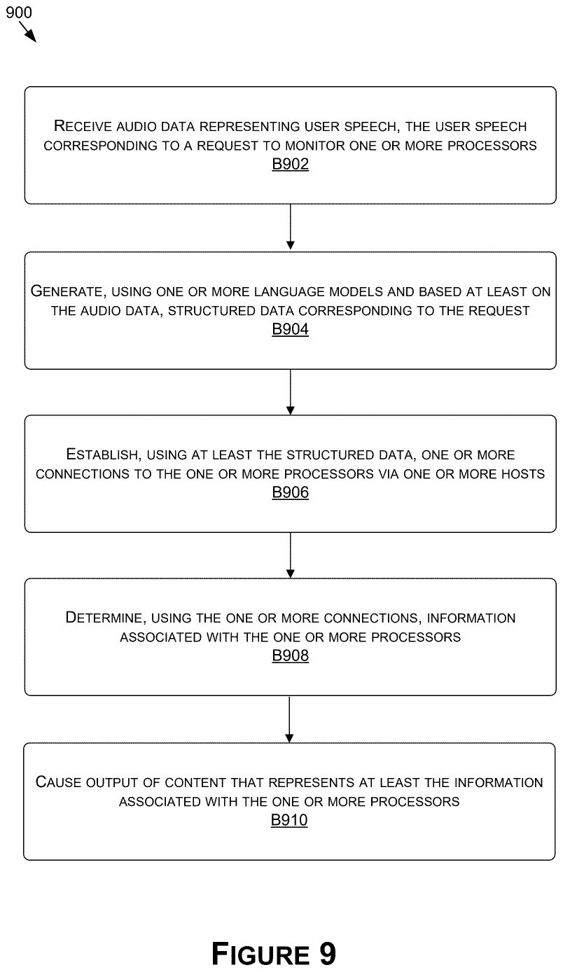

FIG. 9 illustrates a flow diagram showing a method 900 for using one or more language models to monitor one or more processors, in accordance with some embodiments of the present disclosure. The method 900, at block B902, may include receiving audio data representing user speech, the user speech corresponding to a request associated with monitoring one or more processors. For instance, the system(s) 702 may receive the audio data (e.g., the input data 114) corresponding to the request. For example, the user speech may indicate at least one or more identifiers associated with the processor(s) 106 and/or one or more actions to perform with regard to monitoring the processor(s) 106.

The method 900, at block B904, may include generating, using one or more language models and based at least on the audio data, structured data corresponding to the request. For instance, the speech processor(s) 118 may process the audio data to generate the request data 122 that includes a format associated with monitoring the processor(s) 106. As described herein, the speech processor(s) 118 may process the audio data using an ASR model, a NLP model, and/or one or more language models. Additionally, at least the language model(s) may be trained to generate the request data 122 in the format associated with performing the monitoring.

The method 900, at block B906, may include establishing, using the structured data, one or more connections to the one or more processors via one or more hosts. For instance, the monitoring component(s) 120 may use the request data 122 to retrieve registration information associated with the host(s) 110 from the registration database(s) 108. The monitoring component(s) 120 may then use the registration information to establish the connection(s) with the host(s) 110. In some examples, if the monitoring is with regard to multiple processors 106, then the monitoring component(s) 120 may concurrently establish multiple connections with the hosts 110.

The method 900, at block B908, may include determining, using the one or more connections, information associated with the one or more processors. For instance, the monitoring component(s) 120 may cause, using the connection(s), the processor(s) 106 to execute one or more commands to generate the output data 124. In some examples, if the monitoring is again with regard to multiple processors 106, then the monitoring component(s) 120 may cause the processors 106 to execute the command(s) at least partially in parallel. The monitoring component(s) 120 may then use at least the output data 124 to determine the information.

The method 900, at block B910, may include causing output of content that represents at least the information associated with the one or more processors. For instance, the content component(s) 126 may generate the content data 128 representing the information associated with the processor(s) 106. In some examples, the content component(s) 126 may further use historical data from the historical database(s) 130 to generate the content data 128. The system(s) 702 may then send the content data 128 to the user device(s) 112 such that the user device(s) 112 may provide the content.

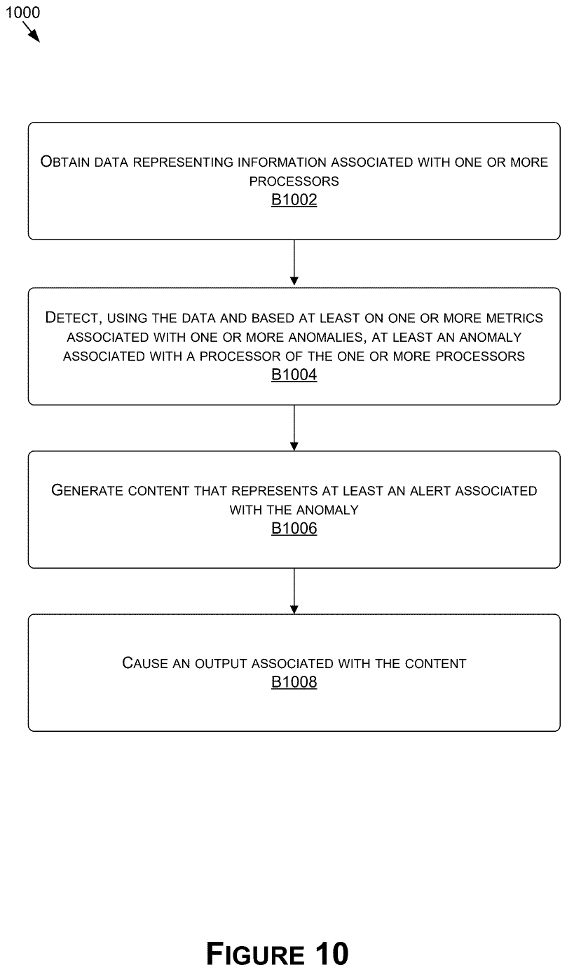

FIG. 10 illustrates a flow diagram showing a method 1000 for automatically detecting anomalies associated with processors, in accordance with some embodiments of the present disclosure. The method 1000, at block B1002, may include obtaining data representing information associated with one or more processors. For instance, the monitoring component(s) 120 may obtain the data representing the information. In some examples, the data may include the output data 124 from the processor(s) 106, the historical data stored in the historical database(s) 130, and/or any other type of data. Additionally, the monitoring component(s) 120 may obtain the data based on the occurrence of one or more events, such as receiving a request to monitor the processor(s) 106, an elapse of a period of time, a problem associated with the processor(s) 106 being detected, and/or any other event.

The method 1000, at block B1004, may include detecting, using the data and based at least on one or more metrics associated with one or more anomalies, at least an anomaly associated with a processor of the one or more processors. For instance, the monitoring component(s) 120 may analyze the information represented by the data using the metric(s). Based at least on the analysis, the monitoring component(s) 120 may determine that at least a metric is satisfied. As such, the monitoring component(s) 120 may detect the anomaly associated with the processor 106.

The method 1000, at block B1006, may include generating content that represents at least an alert associated with the anomaly and the method 1000, at block B1008, may include causing an output associated with the content. For instance, the content component(s) 126 may generate the content data 128 representing the content, where the content indicates at least the alert associated with the anomaly. The system(s) 702 may then cause the output of the content, such as by sending the content data 128 to the user device(s) 112. This way, the system(s) 702 is able to alert one or more users about the anomaly associated with the processor 106.

### EXAMPLE LANGUAGE MODELS

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

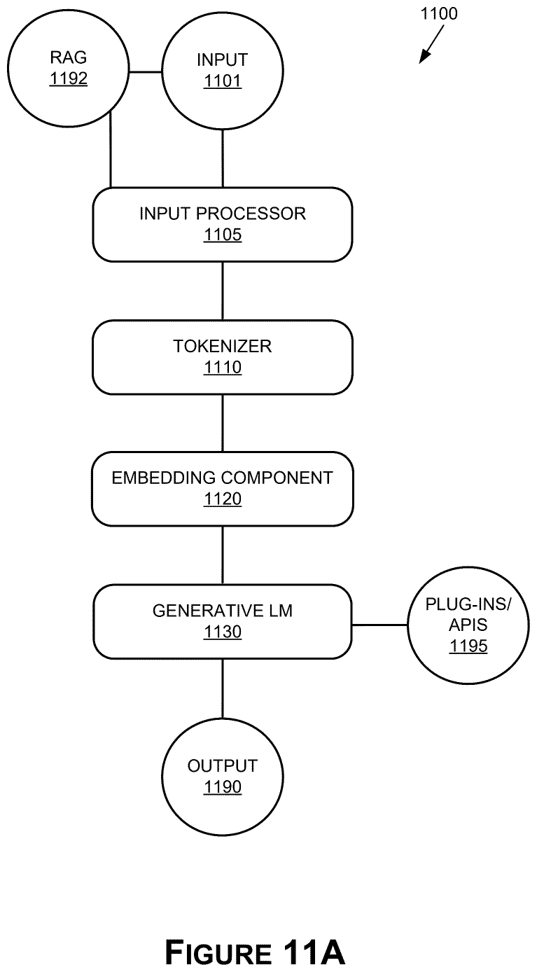

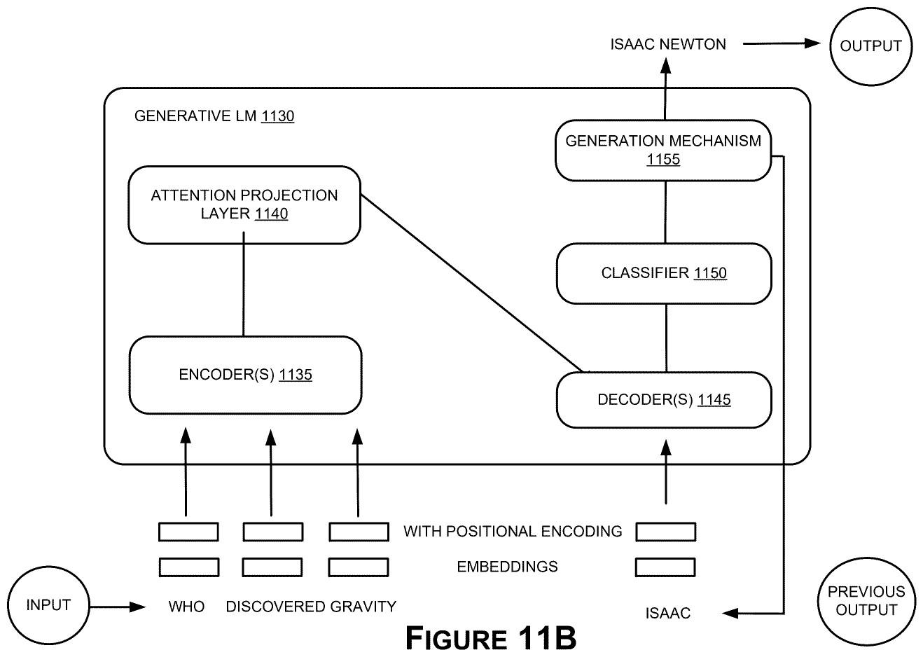

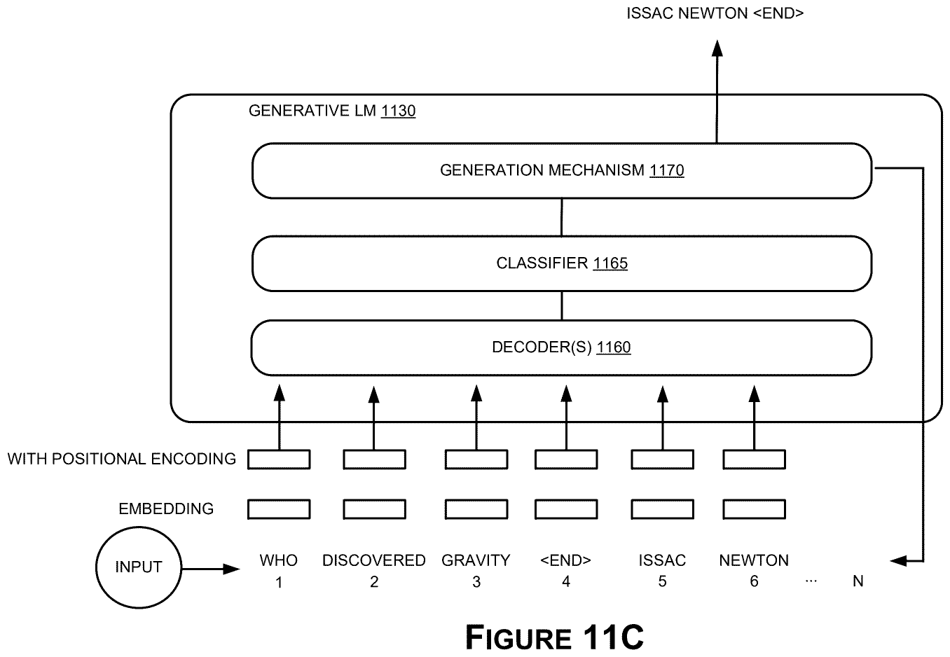

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a SLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1130 (e.g., LLM/SLM/VLM/MMLM/etc.). In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some implementations in which the generative LM 1130 is capable of processing multi-modal inputs, the input 1101 may combine text (or may omit text) with image data, audio data, video data, design data, USD data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 (which may include one or more RAG models, and/or may be performed using the generative LM 1130 itself) may be used to retrieve additional information to be used as part of the input 1101 or prompt. RAG may be used to enhance the input to the LLM/SLM/VLM/MMLM/etc. with external knowledge, so that answers to specific questions or queries or requests are more relevant—such as in a case where specific knowledge is required. The RAG component 1192 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The RAG component 1192 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1192 and the embeddings of the chunks along with the embeddings of the query may be compared to identify the most similar/related embeddings to the query, which may be supplied to the generative LM 1130 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1192 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1110 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1101 includes image data/video data/etc., the input processor 1101 may resize the data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some implementations in which the input 1101 includes audio data, the input processor 1101 may resample an audio file to a consistent sampling rate for uniform processing, and the embedding component 1120 may use any known technique to extract and encode audio features—such as in the form of a spectrogram (e.g., a mel-spectrogram). In some implementations in which the input 1101 includes video data, the input processor 1101 may extract frames or apply resizing to extracted frames, and the embedding component 1120 may extract features such as optical flow embeddings or video embeddings and/or may encode temporal information or sequences of frames. In some implementations in which the input 1101 includes multi-modal data, the embedding component 1120 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1130 and/or other components of the generative LM system 1100 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

FIG. 11B is a block diagram of an example implementation in which the generative LM 1130 includes a transformer encoder-decoder. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example implementation, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example implementation, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example implementation in which the generative LM 1130 includes a decoder-only transformer architecture. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this implementation). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### EXAMPLE COMPUTING DEVICE

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a simulated image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that enable the computing device 1200 to communicate with other computing devices via an electronic communication network, included wired and/or wireless communications. The communication interface 1210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may enable the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that enable detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to enable the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### EXAMPLE DATA CENTER

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R. s”) 1316(1)-1316(N), where “N” represents any whole, positive integer. In at least one embodiment, node C.R. s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1333, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1333 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1333. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A: A method comprising: receiving input data representing a request for first information associated with processors; determining, using one or more databases that store registration data associated with at least the processors, second information for communicating with hosts connected to the processors; establishing, using the second information, connections with the processors via the hosts; causing, using the connections, the processors to perform one or more actions at least partially in parallel to determine the first information associated with the processors; and causing output of content that represents at least the first information associated with the processors.
B: The method of paragraph A, further comprising storing, in one or more second databases that store first historical data associated with the processors, second historical data representing the first information associated with the processors.
C: The method of either paragraph A or paragraph B, further comprising: providing a user interface that includes one or more interface elements associated with requesting the first information; and receiving, using the one or more interface elements, one or more inputs indicating at least one of the processors to monitor or the one or more actions associated with monitoring the processors, wherein the receiving of the input data is based at least on the one or more inputs.
D: The method of any one of paragraphs A-C wherein: the input data includes audio data representing user speech; and the method further comprises determining, using one or more language models and based at least on the audio data, at least one of: identifiers associated with the processors; or the one or more actions for the processors to perform to determine the first information, wherein the determining the second information is based at least on the identifiers.
E: The method of any one of paragraphs A-D further comprising: retrieving, from one or more second databases, historical information associated with the processors, wherein the content further represents at least a portion of the historical information associated with the processors.
F: The method of any one of paragraphs A-E further comprising: determining, based at least on at least one of the first information or historical information associated with the processors, one or more anomalies associated with at least one processor of the processors, wherein the content further represents the one or more anomalies associated with the at least one processor.
G: The method of any one of paragraph A-F further comprising: receiving, from one or more user devices, the registration data associated with the processors, the registration data representing at least one of: the second information for communicating with the hosts connected to the processors; identifiers associated with the processors; account information for connecting to the hosts; or model information associated with the processors; and storing the registration data in the one or more databases.
H: The method of any one of paragraphs A-G wherein the request for the first information associated with the processors comprises at least one of: a first request for general information associated with the processors; a second request for firmware information associated with the processors; a third request for status information associated with the processors; a fourth request for memory information associated with the processors; a fifth request for temperature information associated with the processors; a sixth request for peripheral information associated with the processors; or a seventh request for testing information indicating one or more processors that are capable of performing a test.
I: A system comprising: one or more processors to: receive input data representing a request associated with one or more processors; determine, using one or more databases, registration data for communicating with one or more hosts associated with the one or more processors; establish, using the registration data, one or more connections with the one or more processors via the one or more hosts; cause, using the one or more connections, the one or more processors to execute one or more commands to determine information associated with the one or more processors; and cause output of content that is generated based at least on the information.
J: The system of paragraph I, wherein the one or more processors are caused to execute the one or more commands to determine the information, at least, by: causing, using a first connection of the one or more connections, a first processor of the one or more processors to execute the one or more commands to determine a first portion of the information that is associated with the first processor; and at least partially in parallel with the causing the first processor to execute the one or more commands, causing, using a second connection of the one or more connections, a second processor of the one or more processors to execute the one or more commands to determine a second portion of the information that is associated with the processor.
K: The system of either paragraph I or paragraph J, wherein the one or more processors are further to store, in one or more second databases storing first historical data associated with the one or more processors, second historical data representing at least the information associated with the one or more processors.
L: The system of any one of paragraphs I-K, wherein the one or more processors are further to: provide a user interface that includes one or more interface elements associated with monitoring the one or more processors; and receive, using the one or more interface elements, one or more inputs indicating at least the one or more processors or one or more actions associated with monitoring the one or more processors, the one or more commands corresponding to the one or more actions, wherein the input data is received based at least on the one or more inputs.
M: The system of any one of paragraphs I-L, wherein: the input data includes audio data representing user speech; and the one or more processors are further to determine, using one or more language models and based at least on the audio data, at least one of: one or more identifiers associated with the one or more processors; or one or more actions associated with monitoring the one or more processors, the one or more commands corresponding to the one or more actions.
N: The system of any one of paragraphs I-M, wherein the one or more processors are further to: retrieve, from one or more second databases, historical information associated with the one or more processors; and determine, based at least on the information and the historical information, second information representing an analysis of the one or more processors, wherein the content represents the second information associated with the one or more processors.
O: The system of any one of paragraphs I-N, wherein the one or more processors are further to: determine, based at least on at least one of the information or historical information associated with the one or more processors, one or more anomalies associated with at least one processor of the one or more processors, wherein the content represents the one or more anomalies associated with the at least one processor.
P: The system of any one of paragraphs I-O, wherein the one or more processors are further to: receive, from one or more user devices, the registration data associated with the one or more processors, the registration data representing at least: second information for communicating with the one or more hosts associated with the one or more processors; one or more identifiers associated with the one or more processors; account information for connecting to the one or more hosts; model information associated with the one or more processors; and store the registration data in the one or more databases.
Q: The system of any one of paragraphs I-P, wherein the one or more commands cause the one or more processors to communicate with one or more peripherals to determine at least a portion of the information associated with the one or more processors.
R: The system of any one of paragraphs I-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more small language models (SLMs); a system for performing operations using one or more vision language models (VLMs); a system for performing operations using one or more multi-modal language models (MMLMs); a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.
S: One or more processors comprising: processing circuitry to: receive audio data representing user speech, the user speech corresponding to a request for monitoring one or more second processors; generate, using one or more language models and based at least on the audio data, structured data representing at least one or more identifiers of the one or more second processors and one or more actions associated with the monitoring of the one or more second processors; determine, based at least on causing the one or more second processors perform the one or more actions, information associated with the one or more second processors; and cause an output of content associated with the information.
T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more small language models (SLMs); a system for performing operations using one or more vision language models (VLMs); a system for performing operations using one or more multi-modal language models (MMLMs); a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
receiving input data representing a request for first information associated with processors;
determining, using one or more databases that store registration data associated with at least the processors, second information for communicating with hosts connected to the processors;
establishing, using the second information, connections with the processors via the hosts;
causing, using the connections, the processors to perform one or more actions at least partially in parallel to determine the first information associated with the processors; and
causing output of content that represents at least the first information associated with the processors.

2. The method of claim 1, further comprising storing, in one or more second databases that store first historical data associated with the processors, second historical data representing the first information associated with the processors.

3. The method of claim 1, further comprising:
providing a user interface that includes one or more interface elements associated with requesting the first information; and
receiving, using the one or more interface elements, one or more inputs indicating at least one of the processors to monitor or the one or more actions associated with monitoring the processors,
wherein the receiving of the input data is based at least on the one or more inputs.

4. The method of claim 1, wherein:
the input data includes audio data representing user speech; and
the method further comprises determining, using one or more language models and based at least on the audio data, at least one of:
identifiers associated with the processors; or
the one or more actions for the processors to perform to determine the first information,
wherein the determining the second information is based at least on the identifiers.

5. The method of claim 1, further comprising:
retrieving, from one or more second databases, historical information associated with the processors,
wherein the content further represents at least a portion of the historical information associated with the processors.

6. The method of claim 1, further comprising:
determining, based at least on at least one of the first information or historical information associated with the processors, one or more anomalies associated with at least one processor of the processors,
wherein the content further represents the one or more anomalies associated with the at least one processor.

7. The method of claim 1, further comprising:
receiving, from one or more user devices, the registration data associated with the processors, the registration data representing at least one of:
the second information for communicating with the hosts connected to the processors;
identifiers associated with the processors;
account information for connecting to the hosts; or
model information associated with the processors; and
storing the registration data in the one or more databases.

8. The method of claim 1, wherein the request for the first information associated with the processors comprises at least one of:
a first request for general information associated with the processors;
a second request for firmware information associated with the processors;
a third request for status information associated with the processors;
a fourth request for memory information associated with the processors;
a fifth request for temperature information associated with the processors;
a sixth request for peripheral information associated with the processors; or
a seventh request for testing information indicating one or more processors that are capable of performing a test.

9. A system comprising:
one or more processors to:
receive input data representing a request associated with one or more processors;
determine, using one or more databases, registration data for communicating with one or more hosts associated with the one or more processors;
establish, using the registration data, one or more connections with the one or more processors via the one or more hosts;
cause, using the one or more connections, the one or more processors to execute one or more commands to determine information associated with the one or more processors; and
cause output of content that is generated based at least on the information.

10. The system of claim 9, wherein the one or more processors are caused to execute the one or more commands to determine the information, at least, by:
causing, using a first connection of the one or more connections, a first processor of the one or more processors to execute the one or more commands to determine a first portion of the information that is associated with the first processor; and
at least partially in parallel with the causing the first processor to execute the one or more commands, causing, using a second connection of the one or more connections, a second processor of the one or more processors to execute the one or more commands to determine a second portion of the information that is associated with the processor.

11. The system of claim 9, wherein the one or more processors are further to store, in one or more second databases storing first historical data associated with the one or more processors, second historical data representing at least the information associated with the one or more processors.

12. The system of claim 9, wherein the one or more processors are further to:
provide a user interface that includes one or more interface elements associated with monitoring the one or more processors; and
receive, using the one or more interface elements, one or more inputs indicating at least the one or more processors or one or more actions associated with monitoring the one or more processors, the one or more commands corresponding to the one or more actions,
wherein the input data is received based at least on the one or more inputs.

13. The system of claim 9, wherein:
the input data includes audio data representing user speech; and
the one or more processors are further to determine, using one or more language models and based at least on the audio data, at least one of:
one or more identifiers associated with the one or more processors; or
one or more actions associated with monitoring the one or more processors, the one or more commands corresponding to the one or more actions.

14. The system of claim 9, wherein the one or more processors are further to:
retrieve, from one or more second databases, historical information associated with the one or more processors; and
determine, based at least on the information and the historical information, second information representing an analysis of the one or more processors,
wherein the content represents the second information associated with the one or more processors.

15. The system of claim 9, wherein the one or more processors are further to:
determine, based at least on at least one of the information or historical information associated with the one or more processors, one or more anomalies associated with at least one processor of the one or more processors,
wherein the content represents the one or more anomalies associated with the at least one processor.

16. The system of claim 9, wherein the one or more processors are further to:
receive, from one or more user devices, the registration data associated with the one or more processors, the registration data representing at least:
second information for communicating with the one or more hosts associated with the one or more processors;
one or more identifiers associated with the one or more processors;
account information for connecting to the one or more hosts;
model information associated with the one or more processors; and
store the registration data in the one or more databases.

17. The system of claim 9, wherein the one or more commands cause the one or more processors to communicate with one or more peripherals to determine at least a portion of the information associated with the one or more processors.

18. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more small language models (SLMs);
a system for performing operations using one or more vision language models (VLMs);
a system for performing operations using one or more multi-modal language models (MMLMs);
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

19. One or more processors comprising:
processing circuitry to:
receive audio data representing user speech, the user speech corresponding to a request for monitoring one or more second processors;
generate, using one or more language models and based at least on the audio data, structured data representing at least one or more identifiers of the one or more second processors and one or more actions associated with the monitoring of the one or more second processors;
determine, based at least on causing the one or more second processors perform the one or more actions, information associated with the one or more second processors; and
cause an output of content associated with the information.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more small language models (LLMs);
a system for performing operations using one or more vision language models (VLMs);
a system for performing operations using one or more multi-modal language models (MMLMs);
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
